(19) United States
(12) Patent Application Publication
(10) Pub. No.: US 2009/0198928 A1
(43) Pub. Date: Aug. 6, 2009

(54) METHOD AND SYSTEM FOR PROVIDING DATA BACKUP TO MULTIPLE STORAGE MEDIA

(75) Inventor: Mohan Krishna Kommu CHS, Bangalore (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 12/025,183

(22) Filed: Feb. 4, 2008

(51) Int. Cl. G06F 12/00

(52) U.S. Cl. 711/162; 711/E12.001

(57) ABSTRACT

A method and system for providing automatic data backup to multiple storage media is disclosed herein. An archive pack is used as a data backup and the archive pack comprises: plurality of storage media arranged as pairs, the storage media in the pair are configured to function independently and only one storage medium in the pair is configured to be visible to a user at any time; and a coordinator configured to co-ordinate the storage media in the pair such that data is stored to each storage medium in the pair substantially simultaneously, but separately.

### FIELD OF THE INVENTION

This invention relates generally to backup mechanisms, and more particularly to, a method and system for providing automatic data backup to multiple storage media.

### BACKGROUND OF THE INVENTION

Many types of digital equipment such as computer systems, mobile phones, etc. are provided with memory for storing information. However during the course of time the user tends to accumulate a large amount of data and the data needs to be saved to a backup storage media to ensure the reliability and permanence of the data. Further computer systems and networks are subject to occasional failure and so reliability of the data requires storage of the data using backup systems. The backup system receives a copy of data stored on the computer or computer network where it is stored in the event of either partial or complete failure of the computer system. The data may be retrieved from the backup system to recover from operator error as well.

Generally backup of data is taken at periodic intervals with the assistance of an operator. The user may decide the need and frequency of taking backup data and may need to initiate the process of taking backup of data. Many times the backup is taken as and when the user desires. However the backup systems are most effective when they are used to backup the data regularly, preferably without requiring human intervention. Automated data backup systems perform the backups on a schedule as decided. Hence it is often essential to have a backup device plugged into the computer system whenever a backup is scheduled. Else whenever a data loss is observed on the internal storage device, the backup storage device needs to be reconnected and the data needs to be restored. The process is cumbersome and the required human intervention is significant in case of saving and retrieving data from the backup storage media.

Further conventionally, the backup is taken to a single backup storage media and the corruption or destruction of that storage media may destroy the backup data.

Thus there exists a need to provide a method and system for facilitating automatic backup of data that is more reliable and convenient than conventional backup methods and systems.

### SUMMARY OF THE INVENTION

The above-mentioned shortcomings, disadvantages and problems are addressed herein which will be understood by reading and understanding the following specification.

One embodiment of the present invention provides an archive pack to be used as a data backup. The archive pack comprises: a plurality of storage media arranged as a pair, wherein the storage media in the pair are configured to function independently and only one storage medium in the pair is configured to be visible to a user at any time; and a coordinator configured to coordinate the storage media in the pair such that data is stored in each storage medium in the pair substantially simultaneously, but separately.

In another embodiment, a method of providing automatic data backup is disclosed. The method comprises: providing at least one pair of storage media arranged in a pack, wherein each storage medium in the pair is configured to function independently; facilitating controlled interaction of an operating system media with the storage media; and storing and retrieving data to each storage medium in the pair separately.

In yet another embodiment, a processor-based system having an automatic backup mechanism is disclosed. The system comprises: an accessing unit; an archive pack having at least one pair of storage media operably connected to the accessing unit, wherein each storage medium in the pair is configured to function independently; and a processor configured to facilitate controlled interaction between the archive pack and the accessing unit, and to store data separately in each storage medium in the archive pack.

In yet another embodiment, a medical imaging device is described. The medical imaging device comprises: an imager configured for capturing images; a storage device storing an operating system and capable of storing the captured images; an archive pack configured to have at least one pair of image storage media configured to store images separately in each storage medium in the pack so that images can be retrieved from one storage medium upon corruption of data in the other storage medium; and a processor configured to manage storing and retrieving the images in the storage device and the archive pack.

In yet another embodiment, the invention provides a computer-readable media having two or more computer readable medium for providing automatic data backup. The media comprises: a routine for writing data separately and substantially simultaneously to different storage media; and a routine for providing controlled access to an operating system on the storage media while reading and writing to the different storage media.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram of an archive pack as described in an embodiment of the invention;

FIG. 2 is a flowchart illustrating a method of providing automatic data backup as described in an embodiment of the invention;

FIG. 3 is a block diagram of a processor-based system having an automatic backup mechanism as described in an embodiment of the invention;

FIG. 4 is a block diagram of a medical imaging device as described in an embodiment of the invention;

FIG. 5 is a flowchart illustrating a method of storing data in an archive pack described in an embodiment of the invention;

FIGS. 6A and 6B are flowcharts illustrating a method of data retrieval from an archive pack as described in an embodiment of the invention; and

FIGS. 7A and 7B show diagrammatic illustrations of different modes of connection of an archive pack to a computer in different embodiments of the invention.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

In various embodiments, an archive pack, related methods and systems are disclosed. The archive pack is provided with pairs of storage media, but only one storage medium from the pair is configured to be visible to the user. The data is stored in both the storage media separately and simultaneously such that if one storage medium is corrupted, the data can be retrieved from the other storage medium. The data is automatically written to both of the storage media without any human intervention. The archive pack is detachable from the device to which it is attached. The archive pack can be used with any processor based equipment, where there exists a need to backup data.

In an embodiment, the invention provides an efficient method of storage of data and ensures that a backup of data is taken to multiple storage media at any point of time without any human intervention.

In an embodiment, digital equipment is provided with an automatic back up mechanism. The automatic backup mechanism includes an archive pack with multiple storage media arranged as pairs, for automatically storing the data in duplicate without human intervention.

In an exemplary embodiment the invention provides an imaging device with automatic backup mechanisms. The automated backup mechanism may be configured to have multiple data backup units for taking backup of critical images so that images will be secured even if one or more storage media gets corrupted or damaged. Data is stored separately to the multiple storage media and is isolated from the internal storage media to ensure safety of the data saved in the storage media.

Another aspect of the invention provides an efficient method of carrying data with ensured safety to facilitate computer pooling.

The expression “visible” is used not used in the sense of “visual appearance”, but rather as an “indication”. The expression “storage media not visible to the user” may be read as “the user may not have an indication about the presence of the storage media”.

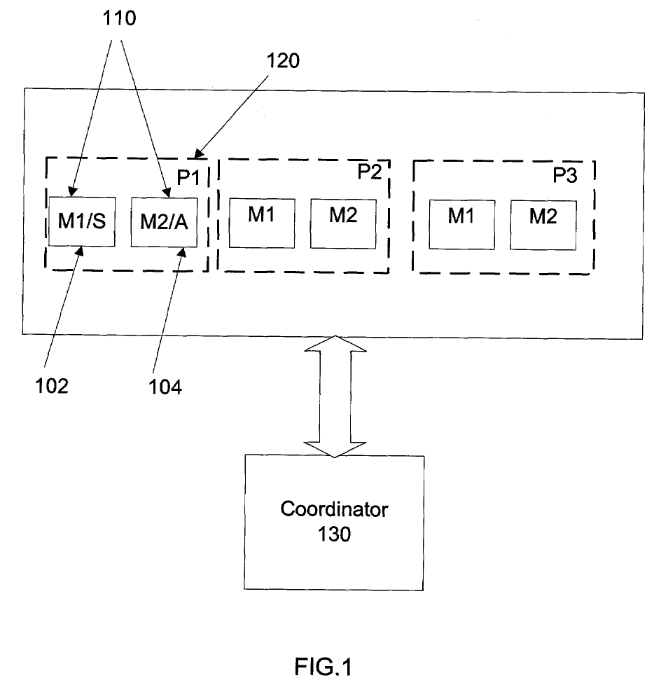

FIG. 1 is a block diagram of an archive pack as described in an embodiment of the invention. The archive pack is provided with a series of storage media 110 functioning independently. The storage media 110 is arranged in the form of pairs 120, of which three pairs are shown in FIG. 1 although the archive pack may include fewer than or more than three pairs in other embodiments of the invention. Each storage media 110 in the pair 120 acts as a mirror image of the other, and preferably have the same specifications although storage media having different specifications may also be used. For example, the storage media 110, denoted as M1 and M2 in the pair P1, 120 preferably have same capacity, same size, and should be of same type. However the storage media 110 in the pair 120 are not electrically connected and they function independently. The storage media 110 in the pair 120 may be termed as a main storage media 102 and an archive media 104. At any time only the main storage media will be visible to the user. This means the user may or may not have indication about the presence of a storage medium.

The archive pack is further associated with a coordinator 130. The coordinator 130 may be a part of the archive pack or may be operably connected to the archive pack. The coordinator 130 is configured to save the data in both the storage media 102 and 104 separately and substantially simultaneously. The coordinator 130 is also configured to isolate the storage media 110 from the user or from an operating system. The coordinator 130 facilitates controlled interaction of the operating system with the storage media 110. Only one storage medium in the storage media 110 will be visible to the user, for example the user will be aware of only the main storage media 102 in the pair 120. The presence of archive media 104 is visible only to the system or device where the archive pack is installed. The coordinator 130 assists in storing the data simultaneously to both the storage media 110 in the pair 120. In an example, the data may be stored initially to the main media and then to the archive media. Before storing the data to the archive media, a data consistency check is performed, to ensure that same data is stored in both the storage media 110. The user may not be aware of the presence of archive media and without user intervention or knowledge that the backup of data is being stored.

In an embodiment, the coordinator 130 can include a set of instructions associated with the storage media 110. The coordinator 130 could be a part of the archive pack. In an example, the coordinator 130 can be provided as embedded software associated with the archive pack. In alternative embodiments, the coordinator 130 can be stored and provided, in readable memory devices such as CDs, pen drives, etc.

In one embodiment, the coordinator 130 is further configured to isolate the storage media 110 from a system operating storage media. The system operating storage media might include operating system instructions and based on the operating system functionality or requirement the data may be stored and retrieved from the storage media. The operating system of the device may decide the location where the data needs to be stored. Alternately the user may select the location of data storage. The device to which the archive pack is connected, can have its own memory like a computer hard disk. The data may be stored in the hard disk as well. The user has the flexibility to save a data in the archive pack or in the hard disk or in both. If the data is saved in the archive pack, the data is stored in two different storage media in the archive pack so that a backup is taken at any time even without the knowledge of the user. Since the coordinator is configured to isolate the operating system storage media from the storage media, the chances of corruption of data stored in the archive pack is minimal.

Further the data storage and retrieval occurs in a controlled manner. The operating system interacts with archive pack and stores the data in the storage medium through the coordinator and the coordinator provides controlled access to the operating system on the storage media.

Once the operating system or user notices a data corruption or data failure, the data can be retrieved from the storage media 110. If the data is stored only in the archive pack, normally the data will be retrieved from the main storage media 102. If the data in the main storage medium 102 is corrupted or the user has deleted data from the main storage medium 102 erroneously, then the coordinator 130 will retrieve the data from the archive media 104. Thus the archive media 104 acts as a data backup media.

Further in another embodiment of the invention, when the device is about to shutdown or the archive pack is about to be detached from the device, a check is performed to make sure that the data in both the storage media remains the same. In case of any inconsistency an alarm is generated. For example, some data might have been deleted from the main storage media 102 erroneously and at the time of unplugging the archive pack or closing the system, the system can retrieve the deleted data from the archive media 104. Similarly in case of any damage to the main storage media 102 or the data stored in the main storage media 102, an alarm is generated. The main storage media 102 and archive media 104 are interchangeable and structural and functional aspects of both the media are same.

The archive pack can be detachably connected to a device where we need to backup of data. The archive pack can also be provided as an integral part of the device.

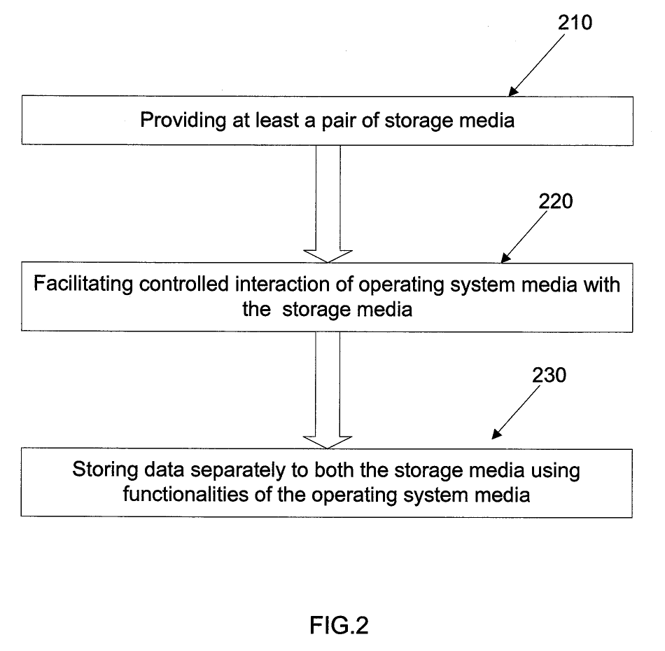

FIG. 2 is flowchart illustrating a method of providing automated backup of data as described in an embodiment of the invention. At step 210, at least one pair of storage media arranged together but functioning independently is provided. At anytime, only one storage media will be visible to the user. The storage media in the pair includes two digital storage media preferably but not necessarily having same capacity. Multiple pairs of storage media can be incorporated in the form of a pack. The storage media may be installed within a system or could be attached to the system. The system may be controlled by an operating system that could be stored in an operating system storage media. At step 220, a controlled interaction between the operating system media and the storage media are facilitated. The operating system does not have direct access on the storage media. The storage and retrieval of the data to or from the storage media could be controlled by the operating system, though the operating system does not have direct access to the storage media. The operating system storage media is isolated from the storage media and the controlled access of the storage media will provide protection of the data stored in the storage media. The data is checked for consistency while storing and retrieving. The consistency check can be performed at any stage and this will ensure the data integrity. At step 230, the data is being stored or retrieved from the storage media. The data is written to both the media substantially simultaneously. In an example, the data is written and retrieved from the storage media based on the operating system requirement or functionality. The operating system is provided with a limited control on the storage media. If the device does not operate based on operating system, then the user may control the data storage. Based on the operating system or user requirement, the data may be stored or retrieved from the storage media. The retrieved contents from the storage media may be displayed.

In an embodiment, the operating system storage media such as hard disc of a computer may be kept as read only and the data can be stored in the archive pack. This will ensure the operating system data saved in the hard disc is not corrupted. The data can be written to the storage media using the functionalities of the operating system. However the operating media will have restricted access on the storage media. In case of any corruption or virus attack at the operating system, it will not be passed to the data storage media.

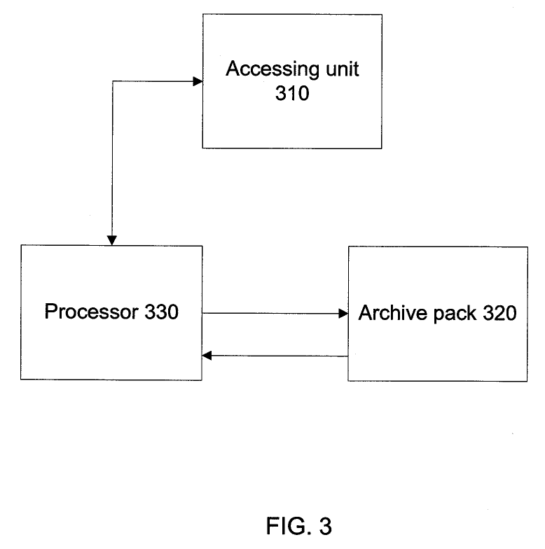

FIG. 3 is a block diagram of a processor-based system having an automatic backup mechanism as described in an embodiment of the invention. The system could include any digital system that requires data backup occasionally or continuously. Examples of the system include computers, laptops, imaging devices such as camera or imaging systems, communication devices etc, but need not be limited to these. The system is configured to include an accessing unit 310, an archive pack 320 for storing the backup data and a processor 330 for facilitating interaction between the accessing unit 310 and the archive pack 320. The processor 330 is configured to process the data and save them appropriately. The processor 330 can be any processor including a microprocessor. The processor 330 may be optionally associated with a system memory. The system might be operated based on instructions from the accessing unit 310. The accessing unit 310 may include an operating system or a user and the operating system instructions can be stored in the system memory. In case of an operating system driven system, the data storage and restoration can be done using the functionalities of the operating system. Different features and functionalities of archive pack 320 is similar to that explained with reference to FIG. 1. The archive pack 320 can have multiple pairs of storage media, wherein each storage medium in the pair is configured to function separately. The archive pack 320 is provided with a pair of storage media each having a Media 1 and Media 2. The Media 1 and Media 2 are not connected to each other and are not part of the same storage media. They are two separate storage medium, but preferably but necessarily of the same size, capacity and type. The processor 330 is configured to facilitate storing and retrieving of the data to or from the archive pack 320. The data is stored in both Media 1 and Media 2 substantially simultaneously, but separately. The processor 330 initially detects the presence of the archive pack 320 in the system and then takes the control of storage and retrieval of data. The accessing unit 310 is provided with restricted access on the storage media. The processor 330 is configured in association with the accessing unit 310 to perform a consistency check whenever data is stored to both the media. If there is an inconsistency with the data stored or retrieved from the storage media in the archive pack, an alarm is generated so that the user can rectify the same. This accommodates the deletion of data from one medium by mistake or presence of bad sector in a storage medium.

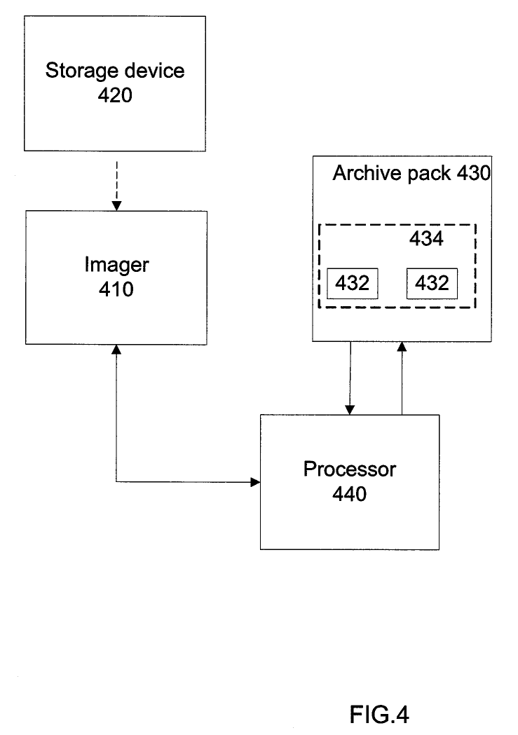

FIG. 4 is a block diagram of a medical imaging device as described in an embodiment of the invention. The medical imaging device is provided with an imager 410 configured to capture images and the imaging device could be provided with a storage device 420 or an internal memory. In an example, the operation of the imaging device is controlled by an operating system. The operating system instructions are stored in the storage device 420 associated with the imaging device. The storage device 420 is capable of storing the images captured by the imager 410. The imaging device in an embodiment is provided with an archive pack 430 configured to act as a backup device for the images. The backup of images or any other data is automatically taken without any user intervention. The archive pack 430 is provided with multiple storage media 432 arranged as pairs 434. Each storage medium 432 in the pair 434 is preferably but not necessarily of same capacity and is of same type. Images can be stored simultaneously in both the storage media 432, but it is stored separately. Upon corruption of one storage medium 432, the data can be retrieved from the other storage medium 432. A processor 440 is provided to control the operation of imaging device. The processor 440 coordinates the image storage and retrieval from the archive pack 430. Further the processor 440 provides controlled access to the operating system on the archive pack. Thus the critical images or any other information is saved to different storage media 432 so that the images are saved safely. The medical imaging device could include ultrasound medical imaging device or any other imaging device that requires having a backup storage media.

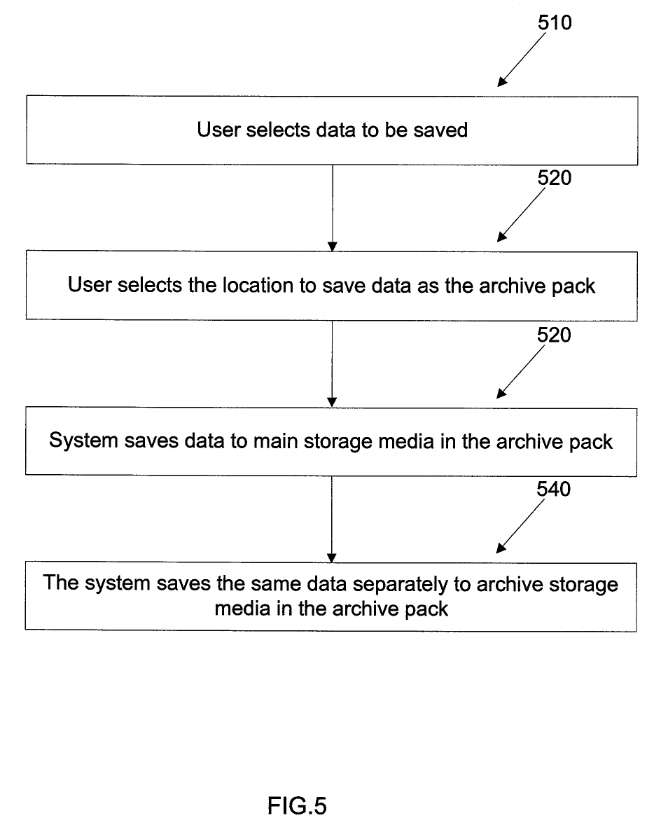

FIG. 5 is a flowchart illustrating a method of storing data to an archive pack described in an embodiment of the invention. At step 510, data to be saved is selected. The system where the data is present may be provided with an archive pack for saving the data. The archive pack is provided with multiple storage media. In an example, the archive pack is provided with two storage media. At step 520, the user selects the option to save data. The user can select the data to be stored to the archive pack connected with the system or may be the internal storage media of the device or to both. In an example the user selects the option of saving data to the archive pack. In this event, the user need not necessarily know about the presence of two storage media in the archive pack. The selection of storage media might depend on the criticality of the data or the portability requirement of the data. At step 530, the data is saved to main storage media termed as Media 1 of the archive pack. Once the data is saved that may be conveyed to the user. At step 540, the same data is saved to an archive media termed as Media 2 in the archive pack. The data is written to both the media substantially simultaneously. Before writing the data to the archive media, a data consistency check may be performed. Since the main storage media, Media 1 and the archive storage media, Media 2 are not connected together, the data is saved to both the media separately. If the data is deleted from the main storage media, the system may wait for a predefined time before deleting the same from the archive media. This takes care of the erroneous deletion of data. Though the data is copied to both the storage media, to the user only one storage medium will be visible.

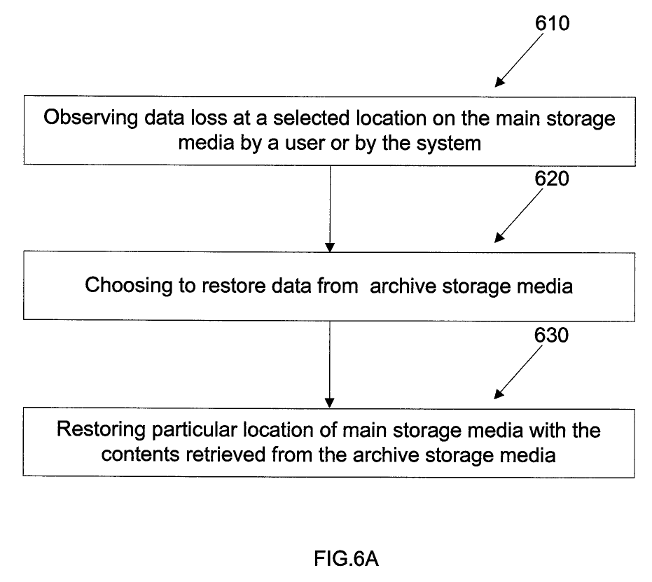

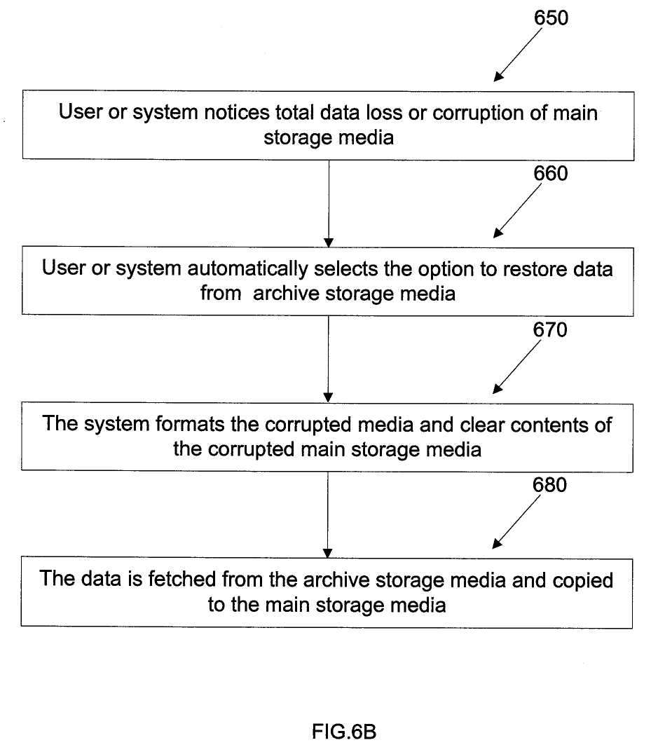

FIGS. 6A and 6B are flowcharts illustrating a method of data retrieval from an archive pack as described in an embodiment of the invention. FIG. 6A illustrates a method of data retrieval, wherein the data is partially lost. The data is stored in an archive pack as explained with reference to FIG. 5. At step 610, the user might observe a data loss at a selected location in the main storage media. The user based on his knowledge could identify the data loss or the system could automatically identify and indicate the corruption of the main storage media. For example, the data might have been accidentally deleted or may be due to bad sector. The bad sector could be due to the incomparability in the data capacity of two storage media. When the data is partially lost, the user might observe the data loss at a particular location on the storage Medial. At step 620, the system may opt to restore the data from the archive storage media. At step 630, the system may automatically retrieve data from the archive media and the retrieved data may be copied to the main storage media without any human intervention.

FIG. 6B illustrates a method of data retrieval wherein the data saved in the main storage media is fully lost. At step 650, the user observes corruption of the whole data in the main storage media. The user or the system may identify the corruption of the main storage media. At step 660, the system or user selects the option to restore the data from the archive storage media. At step 670, the corrupted main storage media is formatted and the contents of the main storage media are cleared. At step 680, the contents of archive storage media is fetched and copied to the main storage media.

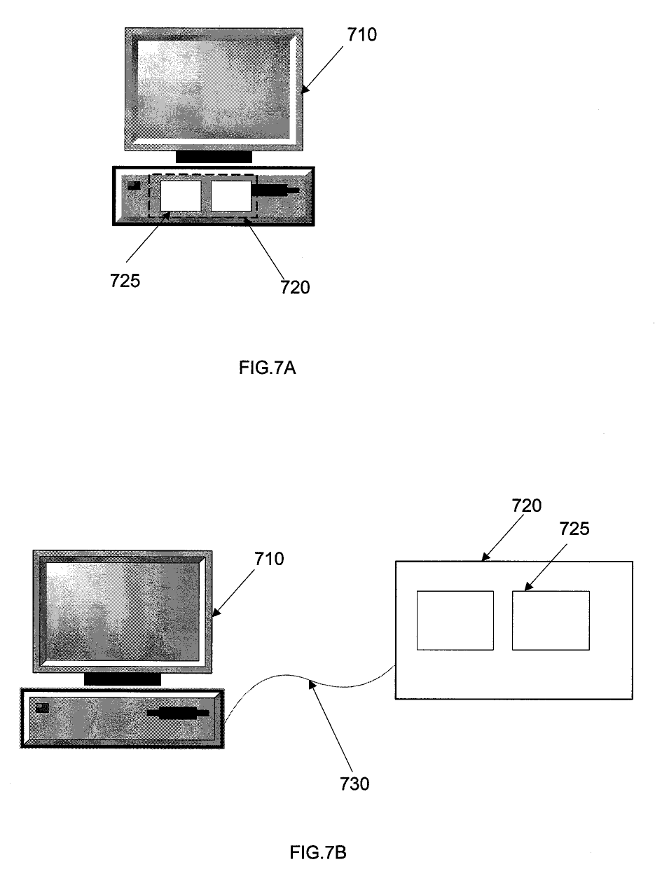

FIGS. 7A and 7B are diagrammatic illustrations of different modes of connection of archive pack 720 to a computer 710 according to different embodiments of the invention. In FIG. 7A the archive pack 720 is internally provided within the computer 710. Along with hardware installation of the archive pack 720, a program capable of coordinating the archive pack 720 to the user or operating system also needs to be installed. This could be provided in the form of readable memory or could be provided as embedded software associated with the archive pack 720. Once the data is to be saved, the archive pack will be listed in the option where the data need to be stored and upon selecting the archive pack, data will be stored to the archive pack 720. The archive pack 720 has two storage media 725 and the data will be stored in both the media separately.

In FIG. 7B, the archive pack 720 is provided external to the computer 710. The archive pack 720 could be connected to the computer 710 through an interface such as a USB port. The user needs to connect the archive pack 720 as and when the data need to be saved. Alternately the archive pack 720 may be kept plugged in to the computer 710 always. Here the archive pack 720 is easily detachable from the computer 710 and this ensures the data portability. The archive pack 720 has two storage media 725 and the data will be stored in both the media separately and will ensure added data safety.

In an exemplary embodiment, an archive pack is constructed using USB Hard Disks packaged together and the data has been restored from one to another. It's implementation of data copy operation is achieved on Linux operating system, using C++ programming. However the operating system or the programming language used and the construction of archive pack need not be limited to this.

Some of the advantages of the invention include automatic data backup to an internal or external device and this eases the user operation. The method ensures enhanced data safety, as the data is stored in multiple storage media. Since operating system is partially isolated from the storage media the changes or corruption of storage media is minimal. This mechanism further increases the portability of data.

The above-description of the embodiments of the methods and systems has the technical effect of providing automatic data backup. The method and system will provide a multi storage media wherein the backup of data is taken at simultaneously to different storage medium so that the data will be able to be retrieved more efficiently.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Exemplary embodiments are described above in detail. The assemblies and methods are not limited to the specific embodiments described herein, but rather, components of each assembly and/or method may be utilized independently and separately from other components described herein. Further the steps involved in the workflow need not follow the sequence in which there are illustrated in figures and all the steps in the work flow need not be performed necessarily to complete the method.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

I claim:

1. An archive pack to be used as a data backup comprising:
a plurality of storage media arranged as a pair, wherein the storage media in the pair are configured to function independently and only one storage medium in the pair is configured to be visible to a user at any time; and
a coordinator configured to co-ordinate the storage media in the pair such that data is stored in each storage medium in the pair substantially simultaneously, but separately.

2. A pack as in claim 1, wherein the storage media include a pack of two digital storage medium of same capacity.

3. A pack as in claim 1, wherein the pair of storage media includes a main storage medium and an archive storage medium.

4. A pack as in claim 1, wherein the coordinator is configured to provide controlled user access to the pair of storage media.

5. A pack as in claim 1, wherein the coordinator is configured to isolate the storage media from an operating system storage media.

6. A pack as in claim 1, wherein the archive pack is detachably connected to a processor based system.

7. A method of providing automatic data backup comprising the steps of:
providing at least one pair of storage media arranged in a pack, wherein each storage medium in the pair is configured to function independently;
facilitating controlled interaction of an operating system media with the storage media; and
storing and retrieving data to each storage medium in the pair separately.

8. A method as in claim 7, wherein the step of providing storage media includes providing at least two storage medium of same type and capacity.

9. A method as in claim 7, wherein the step of facilitating interaction includes:
isolating operating system storage media from the storage media.

10. A method as in claim 9, wherein the step of facilitating interaction includes:
checking consistency of the data on both the storage media during data storage and data retrieval.

11. A method as in claim 10, further comprising: generating an alarm upon detecting inconsistency between the data stored in both the storage media.

12. A method as in claim 7, wherein the step of writing includes: saving data using the operating system functionality in each storage medium in the pair separately.

13. A method as in claim 7, wherein the step of storing and retrieving includes:
displaying contents of the storage media retrieved based on the operating system requirement.

14. A method as in claim 7, wherein the step of storing and retrieving further includes identifying a defect in at least a part of the data stored in one storage medium and fetching the corresponding data from the other storage medium in the pair.

15. A processor-based system having an automatic backup mechanism comprising:
an accessing unit;
an archive pack having at least one pair of storage media operably connected to the accessing unit, wherein each storage medium in the pair is configured to function independently; and
a processor configured to facilitate controlled interaction between the archive pack and the accessing unit, and to store data separately in each storage medium in the archive pack.

16. A system as claimed in claim 15, wherein the accessing unit includes an operating system or a user.

17. A system as claimed in claim 15, wherein the archive pack is a detachable pack.

18. A system as claimed in claim 15, wherein the pair of storage media includes independently functioning two digital storage media of same capacity.

19. A system as claimed in claim 15, wherein the processor is configured to identify the archive pack and control the operation of the pack accordingly.

20. A system as claimed in claim 15, wherein the processor is configured to store and retrieve the data from the archive pack based on at least the functionality of the accessing unit.

21. A medical imaging device comprising:
an imager configured for capturing images;
a storage device storing an operating system and capable of storing the captured images;
an archive pack configured to have at least one pair of image storage media configured to store images separately in each storage medium in the pack so that images can be retrieved from one storage medium upon corruption of data in the other storage medium; and
a processor configured to manage storing and retrieving the images in the storage device and the archive pack.

22. The device as claimed in claim 21, wherein the processor is configured to control the interaction between the storage media and the operating system.

23. The device as claimed in claim 22, wherein the processor is further configured to store and retrieve the images to the archive pack based on the operation system.

24. A computer-readable media having two or more computer readable medium for providing automatic data backup comprising:
a routine for writing data separately and substantially simultaneously to different storage media; and
a routine for providing controlled access to an operating system on the storage media while reading and writing to the different storage media.

25. A computer readable medium as in claim 24, further comprising a routine for reading at least one storage media based on the instructions from operating system functionality.
